(19) United States
(12) Patent Application Publication
(10) Pub. No.: US 2025/0207303 A1
(43) Pub. Date: Jun. 26, 2025

(54) HIGH DEFINITION SCREEN MATERIALS

(71) Applicant: NICO IP, LLC, Fort Myers, FL (US)

(72) Inventor: Nicole Hickey, Fort Myers, FL (US)

(73) Assignee: NICO IP, LLC, Fort Myers, FL (US)

(21) Appl. No.: 19/075,696

(22) Filed: Mar. 10, 2025

Related U.S. Application Data
(63) Continuation-in-part of application No. 18/208,419, filed on Jun. 12, 2023, now Pat. No. 12,247,440.

(51) Int. Cl. D03D 9/00; D02G 3/02; D02G 3/36; D03D 15/283; D03D 15/40; E06B 9/52

(52) U.S. Cl. CPC D03D 9/00; D02G 3/02; D02G 3/36; D03D 15/283; D03D 15/40; E06B 9/52; D10B 2401/063; D10B 2503/00; E06B 2009/524

(57) ABSTRACT

Screen material with improved visibility for use as an insect screen. The screen material is formed of a mesh of polymer coated threads having a denier of 190 to 360, wherein the polymer coated threads comprise 20-30 wt. % polyester thread core and 70-80 wt. % PVC coating.

### CROSS-REFERENCE TO RELATED APPLICATIONS

This application is a continuation-in-part application of U.S. patent application Ser. No. 18/208,419, filed Jun. 12, 2023, now U.S. Pat. No. 12,247,440, the content of which is incorporated herein in its entirety.

### TECHNICAL FIELD

This invention relates generally to screen materials, and more specifically to woven insect screens.

### BACKGROUND

Insect screens have been widely used for over a century on windows and doors to prevent the entry of common insects such as flies, mosquitoes, moths, and bees, as well as other creatures like birds and rodents. Traditionally, these screens have been made from various metals, including low-carbon steel, bronze, stainless steel, and aluminum. More recently, vinyl-coated fiberglass has become the industry standard for insect screens due to its durability and performance.

The woven construction of traditional insect screens inherently compromises both light transmission and optical clarity. Light transmission refers to the amount of light that passes through the screen, while optical clarity pertains to the visual distortion caused by the interference of the screen's wires with the view. Additionally, airflow through the screen is affected by its structure. Over the years, insect screen designs have been refined to achieve a balance between excluding insects and allowing for reasonable visibility and airflow.

Despite these advancements, there remains a significant need in the industry for improved screen materials that optimize both visibility and airflow. Specifically, there is a demand for an “invisible screen” that can effectively exclude even the smallest insects while minimizing impact on visibility and air circulation.

### SUMMARY

The present disclosure provides a screen material that meets this need. The screen material disclosed herein comprises a mesh of intersecting elements, wherein the intersecting elements comprise polymer coated threads having a denier of 420 or less.

The denier of the polymer coated threads may be 360 or less, such as 300 or less, or 250 or less. The denier of the polymer coated threads may be 190 to 250. The denier of the polymer coated threads may be 230 to 270. The denier of the polymer coated threads may be 250.

The polymer coated threads may have a diameter of 0.3 mm to 0.4 mm, such as 0.335 mm.

The polymer coated threads of the screen material may comprise polyvinyl chloride (PVC) coated polyester threads. For example, the polymer coated threads may comprise 20-30% by weight polyester thread core and 70-80% by weight PVC coating, such as 25% by weight polyester thread core and 75% by weight PVC coating, wherein the wt. % is based on the total weight of the polymer coated threads.

The screen material may have a mesh count of 16×14 up to 24×24, such as 17×14 up to 20×20. Exemplary mesh counts include 17×14, 17×17, 17×20, 18×14, 18×16, 20×20, 18×22, 20×24, and 22×24. Such screen materials may find use as an insect screen for small insects.

The screen material may have an areal density of less than 6.5 oz/yard². For example, when the screen material has a mesh count of 20×20, it may have an areal density of less than 6.0 oz/yard², such as less than 5.8 oz/yard², or less than 5.6 oz/yard², or less than 5.4 oz/yard², or even less than 5.2 oz/yard². Alternatively, when the screen material has a mesh count of 17×14, it may have an areal density of less than 5.0 oz/yard², such as less than 4.5 oz/yard², or even less than 4.0 oz/yard².

The screen material may have a mesh count of 24×24, an abrasion resistance of greater than 500, as measured by ASTM D3884-09-2013, and a tensile strength for each of warp and weft of greater than 150 lbf, as measured by ASTM D5035-11. The screen material may have a mesh count of 20×20, an abrasion resistance of greater than 500, as measured by ASTM D3884-09-2013, and a tensile strength for each of warp and weft of greater than 120 lbf, as measured by ASTM D5035-11. The screen material may have a mesh count of 17×14, an abrasion resistance of greater than 500, as measured by ASTM D3884-09-2013, and a tensile strength for each of warp and weft of greater than 70 lbf, as measured by ASTM D5035-11.

The screen material may have an optical clarity of at least 50%, such as at least 55%, or at least 60%, or at least 65%, or at least 75%, or at least 85%, such as 65% to 98% or 75% to 98%.

The screen material may have a light transmission of at least 45%, such as at least 50%, or at least 55%, at least 60%, or at least 70%, such as from 60% to 90% or 70% to 98%.

The screen material may have a % open area, i.e., openness, of at least 35%, such as at least 40%, or at least 45%. The screen material may have a % open area, i.e., openness, of at least 50%, such as at least 52%, or at least 54%, or at least 56%, or at least 58%, or at least 60%, or at least 62%, or at least 64%, or at least 66%, such as 50% to 66%.

The present disclosure also provides screen panels, such as panels positioned within a frame, wherein each side of the frame includes a spline groove having an outward facing opening and a recessed portion, wherein the opening is configured to receive an edge of the screen material and an elastomeric spline component to secure the screen material to the frame side.

The present disclosure also provides screen enclosures formed using the screen material disclosed herein.

Other aspects, features, benefits, and details of the present invention can be more completely understood by reference to the following detailed description of the preferred embodiments, taken in conjunction with the drawings and from the appended claims.

### BRIEF DESCRIPTION OF THE DRAWINGS

In the following figures, like numerals represent like features in the various views. It is to be noted that features and components in these drawings, illustrating the views of embodiments of the present invention, unless stated to be otherwise, are not necessarily drawn to scale.

FIG. 1 is a fragmentary view of a screen material according to the present disclosure.

FIG. 2 is a fragmentary view of a portion of the insect screen material shown in FIG. 1.

FIG. 3 illustrates a typical screened enclosure including screen materials according to the present disclosure.

FIG. 4 illustrates an end view of a support beam configured to accept the screen materials of the present disclosure.

FIG. 5 illustrates an end view of another support beam configured to accept the screen materials of the present disclosure.

FIG. 6 illustrates a close-up detail of section A of the support beam shown in FIG. 4.

### DETAILED DESCRIPTION

The present disclosure provides a screen material useful for excluding insects, i.e., an insect screen, Common insect screens used today include 15×12, 16×16, and 18×14 meshes of plain weave construction. However, in certain geographical regions where small biting midges and sand flies are present, 17×20 and 20×20 mesh screening would be recommended to exclude these insects. The screen materials disclosed herein may have mesh counts of 16×14 up to 24×24, such as 16×15, or 16×16, or 16×17, or 16×18, or 16×19, or 16×20, or 16×21, or 16×22, or 16×23, or 16×24, or 17×14, or 17×15, or 17×17, or 17×18, or 17×19, or 17×20, or 17×21, or 17×22, or 17×23, or 17×24, or 18×14, or 18×15, or 18×18, or 18×19, or 18×20, or 18×21, or 18×22, or 18×23, or 18×24, or 19×14, or 19×15, or 19×19, or 19×20, or 19×21, or 19×22, or 19×23, or 19×24, or 20×14, or 20×15, or 20×20, or 20×21, or 20×22, or 20×23, or 20×24, or 21×21, or 21×22, or 21×23, or 21×24, or 22×22, or 22×23, or 22×24, or 23×23, or 23×24, or 24×24. In certain implementations, the screen materials disclosed herein may have mesh counts of 25×25, 30×30, or even 35×35.

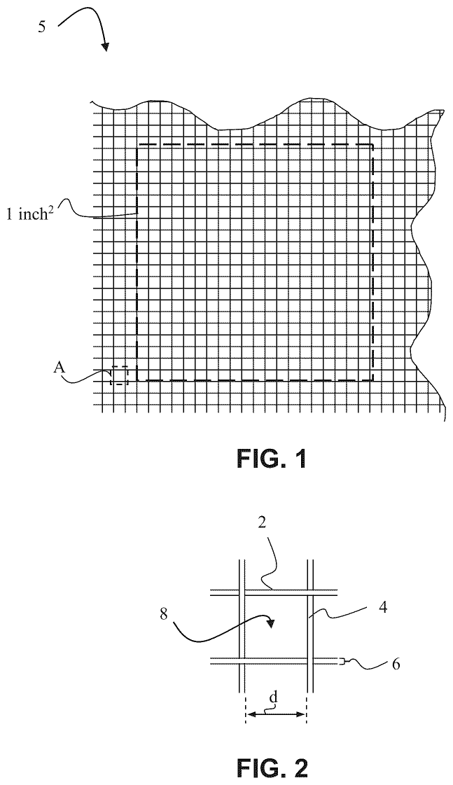

To improve understanding in this disclosure, the term “mesh” will be understood to be a woven or knit material having evenly spaced openings or apertures, and “mesh count” will be understood to be a measure of the number of apertures per inch, which is essentially equivalent to the number of threads that lie in each direction per inch of the mesh. For example, a screen with a 17×20 mesh count would have 17 apertures per inch in one direction and 20 apertures per inch in the perpendicular direction. A mesh (5) having a 20×20 mesh count is shown in FIG. 1. The threads in each direction are referred to as the warp and weft, wherein warp is typically defined as the threads running lengthwise during weaving, while weft is defined as the threads running across the width during weaving. With reference to FIG. 2, an enlarged view of the section of the mesh labelled ‘A’ in FIG. 1 is shown, wherein the warp threads (4) and weft threads (2) are pointed out.

Of note, the mesh count does not provide any information regarding the relative size (diameter “d” of FIG. 2) of the apertures (8) in a woven screen material as different diameter threads will provide different diameter apertures. As used herein, the term “aperture” will be understood to mean the open space between adjacent parallel threads, usually expressed in decimal parts of an inch, and “aperture diameter” is understood to be the dimension of the aperture. For a plain square weave, aperture diameter can be calculated using the equation:

$${A}_{1} = 1 - ( {N}_{1} \times D ) and {A}_{2} = 1 - ( {N}_{2} \times D )$$

where A₁ is the aperture diameter in the warp direction, A₂ is the aperture diameter in the weft direction, N₁ is the number of threads per unit measurement in the warp direction, N₂ is the number of threads per unit measurement in the weft direction and D is the thread diameter (50). Typically, these values are expressed in inches. The percent open area or openness of a screen mesh may then be calculated as:

$${( {A}_{1} \times {A}_{2} )}^{\times } 100.$$

The threads of the presently disclosed screen material are coated with a polymer. The polymer coated threads may have a diameter of 0.3 mm to 0.4 mm, such as 0.305 mm, or 0.310 mm, or 0.315 mm, or 0.320 mm, or 0.325 mm, or 0.330 mm, or 0.335 mm, or 0.340 mm, or 0.345 mm, or 0.350 mm, or 0.355 mm, or 0.360 mm, or 0.365 mm, or 0.370 mm, or 0.375 mm, or 0.380 mm, or 0.385 mm, or 0.390 mm, or 0.395 mm, or 0.400 mm. The polymer coated threads may have a diameter of 0.335 mm.

Most screens on the market today have a thread diameter (6) that is 0.5 mm or more, and a denier that is 420 or greater (>420 d). Denier is a unit of weight used in the textile industry to measure the linear mass density of fibers and is based on a standard mass per length of 1 gram per 9,000 meters of a strand of silk. The polymer coated threads used in forming the screen materials of the present disclosure have much smaller diameters, and much lower denier. For example, the polymer coated threads of the presently disclosed screen materials are less than 420 denier, such as less than 400 denier, 380 denier, 360 denier, 340 denier, 320 denier, 300 denier, 280 denier, or even less than 260 denier. The polymer coated threads of the presently disclosed screen materials may be at least 120 denier, such as at least 140 denier, 160 denier, 180 denier, 200 denier, or even 220 denier. The polymer coated threads of the presently disclosed screen materials may have a denier in a range defined by any of the noted upper and lower limits for denier, such as 140 to 360 denier, or 160 to 300 denier, or 190 to 250 denier, or 230 to 270, or 250.

The low denier of the polymer coated threads of the presently disclosure provide screen materials having a percent open area, or openness of at least 35%, such as at least 40%, or at least 45%, or at least 50%, or at least 55%, or at least 60%. For example, a screen material according to the present disclosure having a 24×24 mesh count may have a percent open area of greater than 30%, such as 35% or more. A screen material according to the present disclosure having a 20×20 mesh count may have a percent open area of greater than 50%, such as 52% or more. A screen material according to the present disclosure having a 17×14 mesh count may have a percent open area of greater than 60%, such as 64% or more.

Moreover, the low denier of the polymer coated threads of the presently disclosure provide screen materials that are lighter weight, i.e., have a lower areal densities, than prior art screen materials, which typically have areal densities of greater than 6.5 oz/yard², depending on the mesh count of the screen material. For example, a standard polymer coated fiberglass screen well known in the art generally has a denier of 420. A 17×14 mesh count of this prior art screen material has an areal density of 6.5 oz/yard², a 17×20 mesh count has an areal density of 7.8 oz/yard², and a 20×20 mesh count has an areal density of 8.2 oz/yard².

The presently disclosed screen materials may have areal densities of less than 6.5 oz/yard². For example, a screen material of the present disclosure having a mesh count of 24×24 may have an areal density of less than 6.5 oz/yard², such as less than 6.4 oz/yard². A screen material of the present disclosure having a mesh count of 20×20 may have an areal density of less than 6.0 oz/yard², such as less than 5.8 oz/yard², or less than 5.6 oz/yard², or less than 5.4 oz/yard², or even less than 5.2 oz/yard². A screen material of the present disclosure having a mesh count of 17×14, may have an areal density of less than 5.0 oz/yard², such as less than 4.5 oz/yard², or even less than 4.0 oz/yard², while a screen material of the present disclosure having a mesh count of 16×14, may have an areal density of less than 4.5 oz/yard², such as less than 4.1 oz/yard², or even less than 3.8 oz/yard² Areal densities for screen materials of the present disclosure having a range of mesh counts are listed in Tables 1 and 2.

Another novel aspect of the presently disclosed screen materials is that the polymer coated threads forming the mesh of the screens are not metals, Rather, the polymer coated threads include a core thread formed of any non-metal fiber, such as polymeric fibers, and may be monofilament or multifilament. Exemplary fibers include at least polyester, nylon, polyolefin, polyamide, polyimide, polyaniline, polypropylene, polyethylene, high density polyethylene (HDPE), polyvinyl alcohol (PVA), polyethylene oxide (PEO), polyurethane (PU/TPU), polysulfone, polyacrylonitrile (PAN), polybenzimidazole (PBI), Further exemplary fibers include fluoropolymers such as ethylene tetrafluoroethylene (ETFE), ethylene chlorotrifluoroethylene (ECTFE), polytetrafluoroethylene (PTFE), fluorinated ethylene propylene (FEP), perfluoroalkoxy (PRA), polyvinylidene fluoride (PVdF), tetrafluoroethylene perfluoromethylvinylether (MFA), tetrafluoroethylene hexafluoropropylene vinylidene fluoride (THV), polyetheretherketone (PEEK), and polyvinylidene fluoride (PVDF), In preferred examples, the core thread comprises polyester.

The polymer coated thread of coated with a polymer such that the thread core is fully encased in the polymer. Exemplary polymers of the polymer coating include vinyl or polyvinyl chloride (PVC). The polymer coating may form up to 60 wt. % of the polymer coated thread, such as up to 65 wt. %, or 70 wt. %, or 75 wt. %, or even up to 80 wt. %, based on the total weight of the polymer coated thread. The polymer coating may be not more than 90 wt. % of the polymer coated thread, such as not more than 85 wt. %, or 80 wt. %, or 75 wt. %, or even not more than 70 wt. %, based on the total weight of the polymer coated thread. The polymer coated threads may include the polymer in a range defined by any of the above noted upper and lower limits, such as 60 wt. % to 90 wt. % or 70 wt. % to 80 wt %, wherein the remainder of the total wt. % comprises the thread.

In a preferred example, the polymer coated thread comprises a polyester thread core having a PVC coating, wherein the polyester thread core comprises 20-30 wt. % and the PVC coating comprises 70-80 wt. %, based on the total weight of the polymer coated thread, i.e., PVC coated polyester thread. In a specific example, the polymer coated thread comprises 25 wt. % of a polyester thread core and 75 wt. % of the PVC coating, based on the total weight of the PVC coated polyester thread.

The screen materials disclosed herein may be woven or knitted using standard weaving or knitting processes. Weaving constructions can include plain weave, twill weave, satin weave, and others such as the leno weave. According to certain aspects, the mesh is constructed by a plain weave of the polymer coated threads.

According to certain aspects, the polymer coating may be applied to the thread before the mesh is formed or after the mesh is formed. When the polymer coating is applied to the thread core before the mesh is formed, the polymer coating of the polymer coated threads may be softened or partially melted to adhere thread junctions to one another, i.e., melt bonding, and thus stabilize the mesh. For example, heat can be generated locally at the fiber intersections by applying ultrasonic energy, such as through an ultrasonic horn and anvil system. This process can be accomplished when the fabric is stationary using a plunge and activate method or may be accomplished in a continuous process using a horn and rotary anvil.

The screen materials disclosed herein may be colored, such as by coloring the polymer coating. Exemplary colors include at least black and white. It has been found that a darker color such as black is preferable to reduce reflective glare. Moreover, the PVC coating may have a matt finish or may include additives to provide a matt finish.

When light interacts with a screen material, many things happen that are important to the visibility of the screen material and the visibility through the screen material. For example, the visibility of a screen material can be influenced by light transmission, reflection, scattering, and variable spectral response resulting from the coatings, dimensions of the polymer coated threads, type of weave design of the mesh, and/or dimensions of the apertures in the mesh. In order to render a screen material nearly invisible and/or improve visibility through the screen, the present inventor has, in addition to other aspects, reduced the denier of the material used to make the screen as discussed above, e.g., denier of the polymer coated threads, to maximize light transmission through the screen material and minimize reflectance from the screen material.

The procedure to measure light transmission through the screen material generally makes use of a spectrometer suitable for measurements at wavelengths of approximately 200 to 3100 nanometers, such as at least in the visible range of wavelengths (380-700 nanometers). Transmission refers to the amount of light that can successfully pass through a material and is usually expressed as a calculated percentage. Thus, for example, thin sheets of clear glass may have a light transmission of nearly 100%.

The screen materials disclosed herein may provide a light transmission of at least 45%, such as at least 50%, or 55%, or 60%, or 65%, or 70%, or 75%, or 80%, or 85%, or even at least 90%. The screen materials disclosed herein may provide a light transmission of up to 99%, such as up to 90%, or 85%, or 80%, or 75%, or 70%. The screen materials disclosed herein may provide light transmission in a range defined by any of the noted upper and lower limits for transmission, such as 45% to 99%, or 55% to 75%, or 60% to 80%.

Optical clarity describes how distorted an image is when you look at it through the screen material and is generally measured as the percentage of regular rays that are diffracted at an angle of less than 2.5 degrees from normal, sometimes referred to as narrow angle scattering. Optical clarity may be measured using a transparency meter, which provides a measurement of the screen's total transmittance. Total transmittance is the ratio of transmitted light to the incident light and may be measured according to ASTM D1003.

The screen materials disclosed herein may provide an optical clarity of at least 50%, such as at least 55%, or 60%, or 65%, or 70%, or 75%, or 80%, or 75%, or even 80%. The screen materials disclosed herein provide an optical clarity of up to 99%, such as up to 95%, or 90%, or 85%, or 80%, or 75%. The screen materials disclosed herein may provide an optical clarity in a range defined by any of the noted upper and lower limits, such as 50% to 99%, or 65% to 90%, or 70% to 95%.

The screen materials disclosed herein are flexible enough to be mounted on a frame using a conventional spline and groove attachment. For example, each side of the frame may include a groove having an outward facing opening and a recessed portion, wherein the outward facing opening is configured to receive an edge of the screen material and an elastomeric spline component to secure the screen material to the frame side.

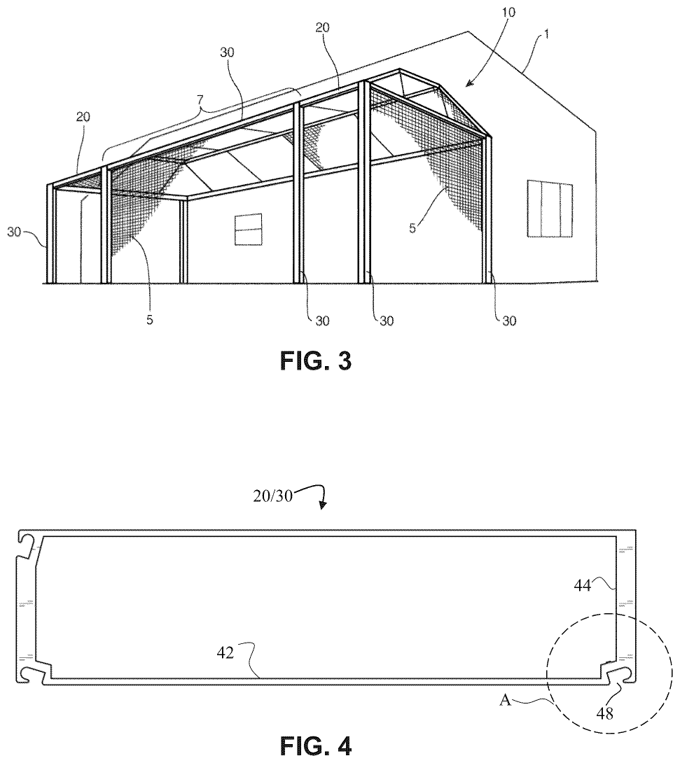

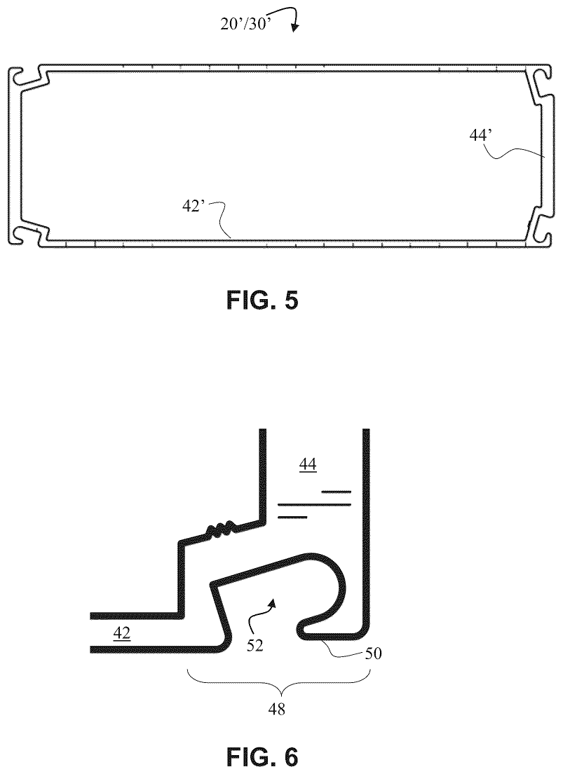

Moreover, since the presently disclosed screen material is light weight, it may be used to span large openings within a frame, such as a frame configured for use in patio and pool enclosures, greenhouses, and the like. An exemplary enclosure 10 attached to a building 1 is shown in FIG. 3, wherein the screen material 5 is shown spanning the region between support beams positioned in the horizontal 20 and vertical 30 orientation. The support beams (20, 30) can be any shape know in the art, such as circular, triangular, hexagonal, square, or rectangular as shown in FIGS. 4 and 5. One or more exterior sides (42, 44) of such beams (20/30) may include a groove 48 that extends longitudinally along a length of the beam. Shown in FIGS. 4 and 5 are support beams according to the present disclosure, wherein FIG. 4 illustrates a support beam (20/30) having three grooves 48 and FIG. 5 illustrates is a support beam (20′/30′) having four grooves. These grooves are configured to accept the screen material and an elastomeric spline material and are thus commonly referred to a spline grooves.

According to the present disclosure, the spline grooves 48 may include an outward facing opening and a recessed portion 52. FIG. 6 illustrates an enlarged view of the spline groove pointed out in section A of FIG. 4, wherein the outward facing opening includes a cap or overhang 50 that may aid in securing an edge of the screen material and the elastomeric spline component within the recessed opening 52 and thus to the support beam (20, 30). When the support beams are installed as the vertical and horizontal beams of an enclosure, the screen material may be sized to fit within an opening defined by the support beams and may be secured along edges thereof within the spline grooves on the beams. That is, an edge region of the screen may be positioned over the spline groove and an elastomeric spline component may be positioned on top of the screen and pushed into the recess 52 of the spline groove, wherein the overhang 50 secures the elastomeric spline component within the recess and secures the screen along an edge of the support beam.

Accordingly, the present disclosure also provides insect screen panels having the insect screen material disclosed herein positioned in a frame. The frame may be formed using three or more of the beams shown in FIGS. 4 and 5. For example, an insect screen panel may include the presently disclosed screen material sized and shaped to fit within a frame formed by the beams, wherein each edge of the screen material is positioned within an adjacent spline groove on a beam of the frame and secured therein by an elastomeric spline component. The beams of the frame each have four flat exterior sides forming a rectangle tube with a hollow interior channel extending longitudinally therethrough, and three or more spline groves, each positioned adjacent an edge of one of the exterior sides. Each of the spline grooves generally include an outward facing opening and a recessed portion, wherein the outward facing opening is configured to receive an edge of the insect screen material and an elastomeric spline component to secure the screen panel to the elongated beam.

As shown in FIG. 4, the beam may have three spline grooves, wherein a first exterior side of the beam comprises a first spline groove that extends longitudinally along a length thereof, and a second exterior side adjacent to the first exterior side comprises second and third spline grooves that extend longitudinally along a length thereof. Alternatively, as shown in FIG. 5, the beam may have four spline grooves, wherein each of a second and forth exterior side of the elongated beam are congruent sides and comprise a first and second spline groove that extends longitudinally along a length thereof, and a third exterior side of the elongated rectangular beam comprises a third and fourth spline groove that extends longitudinally along a length thereof.

Exemplary support beams, panels formed of the support beams, and screened enclosures are disclosed in U.S. Patent Application Pub. No. US 2023/0340773, the entire content of which is incorporated herein by reference.

Various aspects of the screen material and methods of use thereof disclosed herein have been illustrated with reference to one or more exemplary implementations or embodiments. As used herein, the term “exemplary” means “serving as an example, instance, or illustration,” and should not necessarily be construed as preferred or advantageous over other variations of the devices, systems, or methods disclosed herein. “Optional” or “optionally” means that the subsequently described event or circumstance may or may not occur, and that the description includes instances where the event occurs and instances where it does not. In addition, the words “comprising,” “including,” and “having” as used herein mean “including, but not limited to.”

Various aspects of the screen material and methods of use thereof disclosed herein have been illustrated by describing components that are coupled, attached, and/or joined together. As used herein, the terms “coupled,” “attached,” and/or “joined” are interchangeably used to indicate either a direct connection between two components or, where appropriate, an indirect connection to one another through intervening or intermediate components. In contrast, when a component is referred to as being “directly coupled”, “directly attached,” and/or “directly joined” to another component, there are no intervening elements shown in said examples.

Relative terms such as “lower” or “bottom” and “upper” or “top” have been used herein to describe one element's relationship to another element illustrated in the drawings. It will be understood that relative terms are intended to encompass different orientations of aspects of the support brackets in addition to the orientation depicted in the drawings. By way of example, if aspects of screen mesh shown in the drawings are turned over, elements described as being on the “bottom” side of the other elements would then be oriented on the “top” side of the other elements as shown in the relevant drawing. The term “bottom” can therefore encompass both an orientation of “bottom” and “top” depending on the particular orientation of the drawing.

As used herein, the term “substantially” may be taken to represent the inherent degree of uncertainty that may be attributed to any quantitative comparison, value, measurement, or other representation. Thus, the term substantially may mean an amount of generally at least 80%, 90%, 95%, 98%, or even 99% of a stated value.

It must also be noted that as used herein and in the appended claims, the singular forms “a,” “an,” and “the” include the plural reference unless the context clearly dictates otherwise. Thus, for example, reference to “a” polymer coated thread, “an” insect screen, or “the” polymer is a reference to one or more polymer coated threads, insect screens, or polymers and equivalents thereof known to those skilled in the art, and so forth. Unless defined otherwise, all technical and scientific terms used herein have the same meanings as commonly understood by one of ordinary skill in the art.

The use of “or” means “and/or” unless specifically stated otherwise.

Other than in any operating examples, or where otherwise indicated, all numbers expressing, for example, quantities of ingredients used in the specification and claims are to be understood as being modified in all instances by the term “about.” Accordingly, unless indicated to the contrary, the numerical parameters set forth in the specification and appended claims are approximations that may vary depending upon at least the substrate used, the type and form of touch sensitive and display surfaces, and the size of the assembly or device comprising the assembly. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

When ranges are given, any endpoints of those ranges and/or numbers within those ranges can be combined within the scope of the present invention.

### Examples

Screen materials having 20×20 and 17×14 mesh counts according to the present disclosure were produced using 250 denier PVC coated polyester threads as a standard plain weave. These screens were compared to prior art screens having 420 denier coated fiberglass threads as 20×20, 17×20, and 17×14 mesh counts in a standard plain weave.

The areal densities, thread denier, and wear characteristics for each of these samples are provided in Table 1 below. Table 2 includes areal densities and percent open area (openness) for inventive screen materials having a wide range of mesh counts. Of note, the overall areal density of the inventive screens of the present disclosure are much lower than those of the comparative prior art samples.

TABLE 1
Inventive versus Comparative Screen Materials

| Sample | Inventive | | Comparative* | | | |
|---|---|---|---|---|---|---|
| apertures per inch: | 17 × 14 | 20 × 20 | 17 × 14 | 17 × 14 | 17 × 20 | 20 × 20 |
| warp × weft | | | | | | |
| Areal Density | 3.86 | 5.08 | 13.13 | 6.50 | 7.84 | 8.20 |
| (ounces/yard²) | | | | | | |
| Denier | 250 | 250 | 1000 | 420 | 420 | 420 |
| Thickness, mm | 0.47 | 0.48 | 0.77 | 0.57 | 0.61 | 0.58 |
| Diameter of the polymer coated | 0.335 | 0.335 | 0.52 | 0.43 | 0.43 | 0.43 |
| threads, mm | | | | | | |
| Tensile Strength (Strip), lbf | 128.52, 78.75 | 129.94, 139.33 | 647.9, 478.5 | 171.51, 162.29 | 183.48, 182.55 | 204.07, 210 |
| ASTM D5035-11 | | | | | | |
| warp, weft | | | | | | |
| Tear Strength (Trapezoidal), lbf | 32.3, 33.74 | 15.3, 13.91 | 81.1, 59.0 | 50.97, 55.67 | 53.55, 44.62 | 32.03, 34.27 |
| ASTM D2261-13 | | | | | | |
| warp, weft | | | | | | |
| % open area | 63 | 54 | 46 | 54 | 47 | 43 |

*Superscreen ®

TABLE 2
Inventive Screen Materials

| | apertures per inch: warp × weft | | | | | | | | |
|---|---|---|---|---|---|---|---|---|---|
| | 16 × 14 | 16 × 18 | 16 × 20 | 17 × 17 | 18 × 14 | 18 × 16 | 20 × 14 | 20 × 18 | 24 × 24 |
| Areal Density | 3.72 | 4.31 | 4.6 | 4.31 | 4.01 | 4.31 | 4.37 | 4.90 | 6.37 |
| (ounces/yard²) | | | | | | | | | |
| Denier | 250 | 250 | 250 | 250 | 250 | 250 | 250 | 250 | 250 |
| Diameter of | 0.335 | 0.335 | 0.335 | 0.335 | 0.335 | 0.335 | 0.335 | 0.335 | 0.335 |
| the polymer | | | | | | | | | |
| coated | | | | | | | | | |
| threads, mm | | | | | | | | | |
| % open area | 64.5 | 58.6 | 55.7 | 58.6 | 61.3 | 58.6 | 58.6 | 52.7 | 38.0 |

What is claimed is:

1. A screen material comprising:
a mesh of intersecting polymer coated threads, wherein the polymer coated threads have a denier of 190 to 270 and comprise 20 to 30 wt. % of a polyester thread core and 70 to 80 wt. % of a polyvinyl chloride (PVC) coating over the polyester thread core, wherein the wt. % is based on a total weight of the polymer coated threads,
wherein the screen material has:
a mesh count of 16×14 up to 24×24,
a % open area of at least 35%, and
an areal density of less than 6.5 oz/yard².

2. The screen material of claim 1, wherein the mesh of intersecting polymer coated threads form substantially rectangular openings.

3. The screen material of claim 1, wherein the mesh of intersecting polymer coated threads have a denier of 230 to 270.

4. The screen material of claim 1, wherein the mesh of intersecting polymer coated threads have a denier of 250.

5. The screen material of claim 1, wherein the mesh of intersecting polymer coated threads comprise 25 wt. % of the polyester thread core and 75 wt. % of the PVC coating over the polyester thread core, wherein the wt. % is based on a total weight of the polymer coated threads.

6. The screen material of claim 1, wherein the mesh count of the screen material is 16×14 up to 20×20 and the areal density of the screen material is less than 5.5 oz/yard².

7. The screen material of claim 1, wherein the mesh count of the screen material is 16×14 up to 20×20, the areal density of the screen material is less than 5.5 oz/yard², and the % open area is at least 50%.

8. The screen material of claim 1, wherein the mesh count is 17×14 up to 24×24, and the screen material has an abrasion resistance of greater than 500, as measured by ASTM D3884-09-2013, and a tensile strength for each of warp and weft of greater than 70 lbf, as measured by ASTM D5035-11.

9. The screen material of claim 1, wherein the mesh count of the screen material is 16×14 up to 18×16 and the areal density of the screen material is less than 4.5 oz/yard².

10. A screen material comprising:
a mesh of intersecting polymer coated threads, wherein the polymer coated threads have a denier of 250 and comprise 25 wt. % of a polyester thread core and 75 wt. % of a polyvinyl chloride (PVC) coating over the polyester thread core, wherein the wt. % is based on a total weight of the polymer coated threads,
wherein the screen material has:
a mesh count of 20×20 up to 24×24,
a % open area of at least 35%,
an areal density of less than 6.5 oz/yard², and
an abrasion resistance of greater than 500, as measured by ASTM D3884-09-2013, and a tensile strength for each of warp and weft of greater than 120 lbf, as measured by ASTM D5035-11.

11. A screen material comprising:
a mesh of intersecting polymer coated threads, wherein the polymer coated threads have a denier of 250 and comprise 25 wt. % of a polyester thread core and 75 wt. % of a polyvinyl chloride (PVC) coating over the polyester thread core, wherein the wt. % is based on a total weight of the polymer coated threads,
wherein the screen material has:
a mesh count of 17×14 up to 20×20,
a % open area of at least 50%,
an areal density of less than 6.0 oz/yard²,
a light transmission of at least 50%, and
an abrasion resistance of greater than 500, as measured by ASTM D3884-09-2013, and a tensile strength for each of warp and weft of greater than 70 lbf, as measured by ASTM D5035-11.

12. A screen panel comprising:
a frame formed by at least three elongated beams, each beam comprising four flat exterior sides forming a rectangular tube with a hollow interior channel extending longitudinally therethrough, and three or more spline groves, each positioned adjacent an edge of one of the exterior sides; and
the screen material of claim 1,
wherein the screen material is sized and shaped to fit within the frame and all edges of the screen material are positioned within an adjacent spline groove and secured therein.

13. The screen panel of claim 12, wherein each of the spline grooves include an outward facing opening and a recessed portion, wherein the outward facing opening is configured to receive an edge of the screen material and an elastomeric spline component to secure the screen panel to the elongated beam.

14. The screen panel of claim 12, wherein a first exterior side of the elongated beam comprises a first spline groove that extends longitudinally along a length thereof, and a second exterior side adjacent to the first exterior side comprises second and third spline grooves that extend longitudinally along a length thereof.

15. The screen panel of claim 12, wherein each of a second and forth exterior side of the elongated beam are congruent sides and comprise a first and second spline groove that extends longitudinally along a length thereof, and a third exterior side of the elongated rectangular beam comprises a third and fourth spline groove that extends longitudinally along a length thereof.

16. A screened enclosure comprising the screen panels of claim 12.

17. A screen panel comprising:
a frame formed by at least three elongated beams, each beam comprising four flat exterior sides forming a rectangular tube with a hollow interior channel extending longitudinally therethrough, and three or more spline groves, each positioned adjacent an edge of one of the exterior sides; and
the screen material of claim 10,
wherein the screen material is sized and shaped to fit within the frame and all edges of the screen material are positioned within an adjacent spline groove and secured therein.

18. A screened enclosure comprising the screen panels of claim 17.

19. A screen panel comprising:
a frame formed by at least three elongated beams, each beam comprising four flat exterior sides forming a rectangular tube with a hollow interior channel extending longitudinally therethrough, and three or more spline groves, each positioned adjacent an edge of one of the exterior sides; and
the screen material of claim 11,
wherein the screen material is sized and shaped to fit within the frame and all edges of the screen material are positioned within an adjacent spline groove and secured therein.

20. A screened enclosure comprising the screen panels of claim 19.
